(19) United States
(12) Patent Application Publication
(10) Pub. No.: US 2012/0095784 A1
(43) Pub. Date: Apr. 19, 2012

(54) MEDICATION INSURANCE SYSTEMS AND METHODS

(76) Inventor: Ryan Hamilton, Smyrna, GA (US)

(21) Appl. No.: 13/269,768

(22) Filed: Oct. 10, 2011

Related U.S. Application Data
(60) Provisional application No. 61/392,517, filed on Oct. 13, 2010.

(51) Int. Cl. G06Q 40/08

(52) U.S. Cl. 705/4

(57) ABSTRACT

A computer-readable medium storing computer readable instructions for: (1) receiving a request to fill a prescription for a prescribed medication; (2) determining whether it would be possible to legally replace the prescribed medication if the prescribed medication were to become subject to an event selected from a group consisting of loss, theft, and damage; and (3) in response to determining that it would be possible to legally replace the prescribed medication if the prescribed medication were to become subject to an event selected from a group consisting of loss, theft, and damage, facilitating the offering of a medication insurance plan covering the prescribed medication. The medication insurance plan may, for example, insure the prescribed medication against loss, theft, and/or damage.

### CROSS-REFERENCE TO RELATED APPLICATIONS

This application claims priority from U.S. Provisional Application 61/392,517, filed on Oct. 13, 2010, entitled Medication Insurance Systems and Methods, which is hereby incorporated herein by reference in its entirety.

### BACKGROUND

Insurance companies will not typically pay to replace prescription medications that are lost, damaged, or stolen. As a result, customers are often left with a difficult dilemma—either pay potentially exorbitant fees to replace their lost, damaged, or stolen medication, or go without the medication altogether. In cases where a patient decides to go without the medication, the patient often permanently stops taking the medication, which in certain situations can place the patient's health at grave risk. Accordingly, there is a need for improved systems and methods for preventing gaps in the use of a particular medication that may occur when a user's medication is lost, stolen, or damaged.

### SUMMARY

A computer system, according to various embodiments, is adapted for: (1) receiving a request to fill a prescription for a prescribed medication; (2) determining whether it would be possible to legally replace the prescribed medication if the prescribed medication were to become lost, stolen, and/or damaged; and (3) in response to determining that it would be possible to legally replace the prescribed medication if the prescribed medication were to become lost, stolen, and/or damaged, facilitating the offering of a medication insurance plan covering the prescribed medication against loss, theft, and/or damage.

A computer system, according to further embodiments, is adapted for: (1) receiving a claim to cover the cost of replacing a particular prescription medication; (2) determining whether the prescription medication is covered by a medication insurance plan, wherein the medication insurance plan protects the prescription medication against at loss, theft and/or damage; (3) determining, in a substantially automated manner, whether it would be possible to legally replace the prescription medication; and (4) at least partially in response to determining that the missing prescription medication is covered by the medication insurance plan and that it would be possible to legally replace the prescription medication, authorizing payment of the claim.

A method of providing a medication insurance plan, according to various embodiments, comprises the steps of: (1) receiving a request to fill a prescription for prescription medication; and (2) at least partially in response to receiving the request, issuing an offer to provide a medication replacement plan that would at least partially cover the cost of replacing the prescription medication if the medication becomes subject to an event selected from a group consisting of loss, theft, and damage.

### BRIEF DESCRIPTION OF THE DRAWINGS

Having thus described various embodiments in general terms, reference will now be made to the accompanying drawings, which are not necessarily drawn to scale, and wherein:

FIG. 1 is a block diagram of a Medication Insurance System according to one embodiment.

FIG. 2 is a block diagram of the Medication Insurance Server of FIG. 1.

FIG. 3 is a flowchart that generally illustrates a Medication Insurance Provision Module according to a particular embodiment.

FIGS. 4A-4B depict a flowchart that generally illustrates a Medication Insurance Claims Module according to a particular embodiment.

### DETAILED DESCRIPTION OF VARIOUS EMBODIMENTS

Various embodiments will now be described more fully hereinafter with reference to the accompanying drawings, in which various relevant embodiments are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

Computer systems and/or methods according to particular embodiments are adapted for facilitating the provision of insurance that covers expenses related to replacing one or more medications (e.g., prescription or non-prescription medications) in the event that the medications become unavailable to the individual who is taking the medications. For example, an applicable insurance policy may cover the cost of replacing any lost medication that was provided to a patient as part of filling or refilling a particular prescription. In various embodiments, if the patient loses access to the medication (e.g., the medication is lost, stolen, or damaged, or otherwise becomes inaccessible to the patient) the insurance would at least partially cover the cost of replacing the medication. In some embodiments, the insurance would only be issued for refillable prescriptions with at least one refill left on the prescription. In other embodiments, the insurance would also be available for non-refillable prescriptions if it would be legally possible to obtain a replacement prescription for the medication. In such cases, the insurance company providing the policy may, in certain embodiments, facilitate obtaining a replacement prescription for the patient (e.g., by contacting the patient's healthcare provider and requesting that the healthcare provider authorize a new prescription over the phone). In other embodiments, if permitted by law, the insurance company may replace the medication directly.

In particular embodiments, the medication insurance may cover: (1) all remaining refills on a particular prescription; (2) the patient's current refill; or (3) the initial filling of the prescription. For example, if the prescription provides for twelve remaining monthly refills (e.g., a new, yearlong prescription), the medication insurance may insure the patient against any loss, theft, and damage to only the medication obtained when the patient first fills the prescription, or the insurance may be effective for the first month's worth of medication as well as any of the 11 monthly refills.

Computer systems according to various embodiments include at least one processor and memory, and are adapted to facilitate the provision of medication insurance by, for example: (1) determining whether medication insurance would be available for a particular medication and/or a particular prescription for the medication; (2) facilitating the issuance of new medication insurance policies; (3) facilitating the maintenance of existing medication insurance policies; and/or (4) processing claims to be paid under such policies.

### Exemplary Technical Platforms

As will be appreciated by one skilled in the relevant field in view of this disclosure, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., software) embodied in the storage medium. More particularly, the present invention may take the form of web-implemented computer software. Any suitable computer-readable storage medium may be utilized including hard disks, DVDs, CD-ROMs, optical storage devices, flash drives, and/or magnetic storage devices.

Various embodiments of the system are described below with reference to block diagrams and flowchart illustrations of methods, apparatuses (e.g., systems) and computer program products according to a particular embodiment. It will be understood that each block of the block diagrams and flowchart illustrations, and combinations of blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

The computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions and other hardware executing appropriate computer instructions.

### Exemplary System Architecture

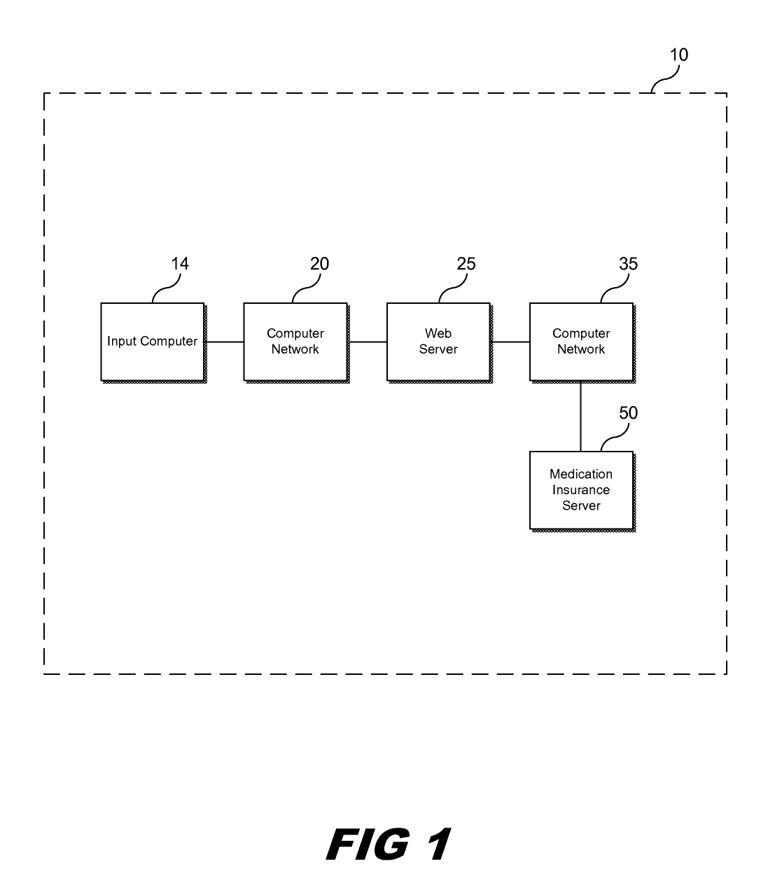

FIG. 1 shows a block diagram of a Medication Insurance System 10 according to a particular embodiment. As may be understood from this figure, the Medication Insurance System 10 includes a Medication Insurance Server 50 (which may, for example, include one or more computer servers), one or more computer networks 20, 35, a Web Server 25, and at least one Input Computer 14 (e.g., at least one pharmacy computer, patient computer, or any other suitable input device). The one or more computer networks 20, 35 facilitate communication between the Input Computer 14, the web server 25, and the Medication Insurance Server 50. These one or more computer networks 20, 35 may include any of a variety of types of computer networks such as the Internet, a private intranet, a public switch telephone network (PSTN), or any other type of network. In certain variations of the embodiment shown in FIG. 1, the communication link between the Input Computer 14 and the Web Server 25 is implemented via the Internet using Internet protocol (IP). The communication link between the Web Server 25 and the Medication Insurance Server 50 may be, for example, implemented via a Local Area Network (LAN) or via the Internet.

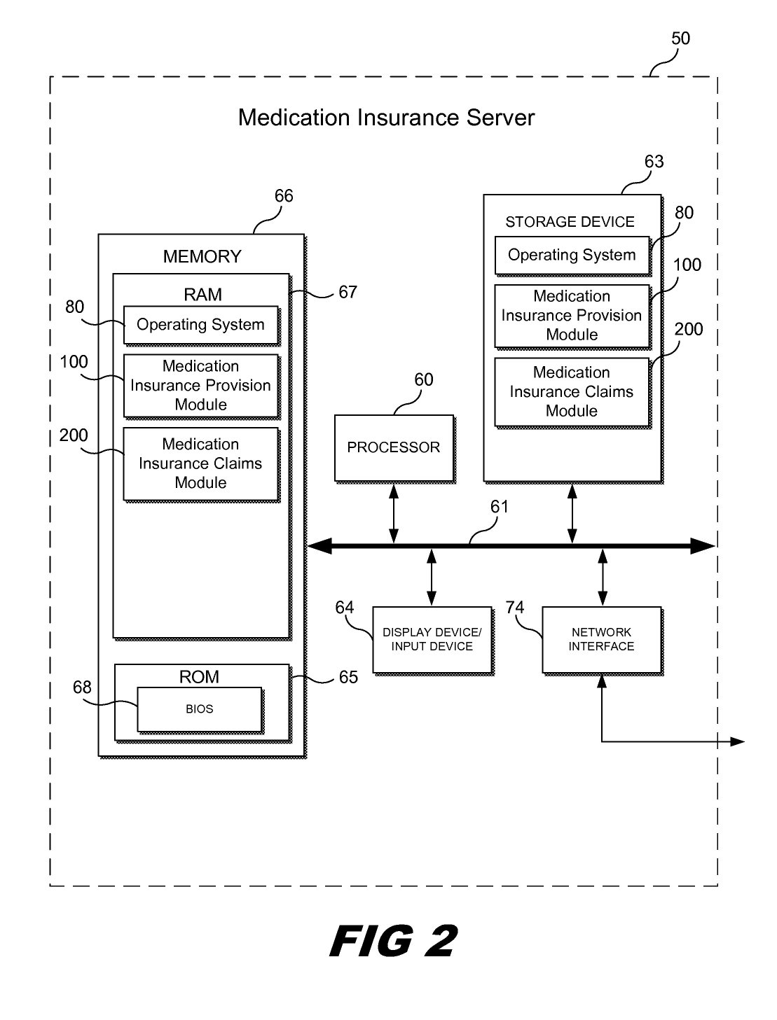

FIG. 2 shows a block diagram of an exemplary embodiment of the Medication Insurance Server 50 of FIG. 1. The Medication Insurance Server 50 includes a processor 60 that communicates with other elements within the Medication Insurance Server 50 via a system interface or bus 61. Also included in the Medication Insurance Server 50 is a display device/input device 64 for receiving and displaying data. This display device/input device 64 may be, for example, a keyboard, voice recognition, or pointing device that is used in combination with a monitor. The Medication Insurance Server 50 further includes memory 66, which preferably includes both read only memory (ROM) 65 and random access memory (RAM) 67. The server's ROM 65 is used to store a basic input/output system 68 (BIOS) that contains the basic routines that help to transfer information between elements within the Medication Insurance Server 50.

In addition, the Medication Insurance Server 50 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for the Medication Insurance Server 50. It is important to note that, in various embodiments, the computer-readable media described above could be replaced by any other type of computer-readable media (e.g., magnetic cassettes, flash memory cards, digital video disks, and Bernoulli cartridges).

A number of program modules may be stored by the various storage devices and within RAM 67. Such program modules include an operating system 80, a Medication Insurance Provision Module 100, and a Medication Insurance Claims Module 200. The Medication Insurance Provision Module 100 and Medication Insurance Claims Module 200 control certain aspects of the operation of the Medication Insurance Server 50, as is described in more detail below, with the assistance of the processor 60 and an operating system 80.

Also located within the Medication Insurance Server 50 is a network interface 74 for interfacing and communicating with other elements of a computer network. It will be appreciated by one of ordinary skill in the art that one or more of the Medication Insurance Server 50 components may be located geographically remotely from other Medication Insurance Server 50 components. Furthermore, one or more of the components may be combined, and additional components performing functions described herein may be included in the Medication Insurance Server 50.

### Exemplary System Modules

As noted above, various aspects of the system's functionality may be executed by certain system modules, including the system's Medication Insurance Provision Module 100 and Medication Insurance Claims Module 200. These modules are discussed in greater detail below.

### Medication Insurance Provision Module

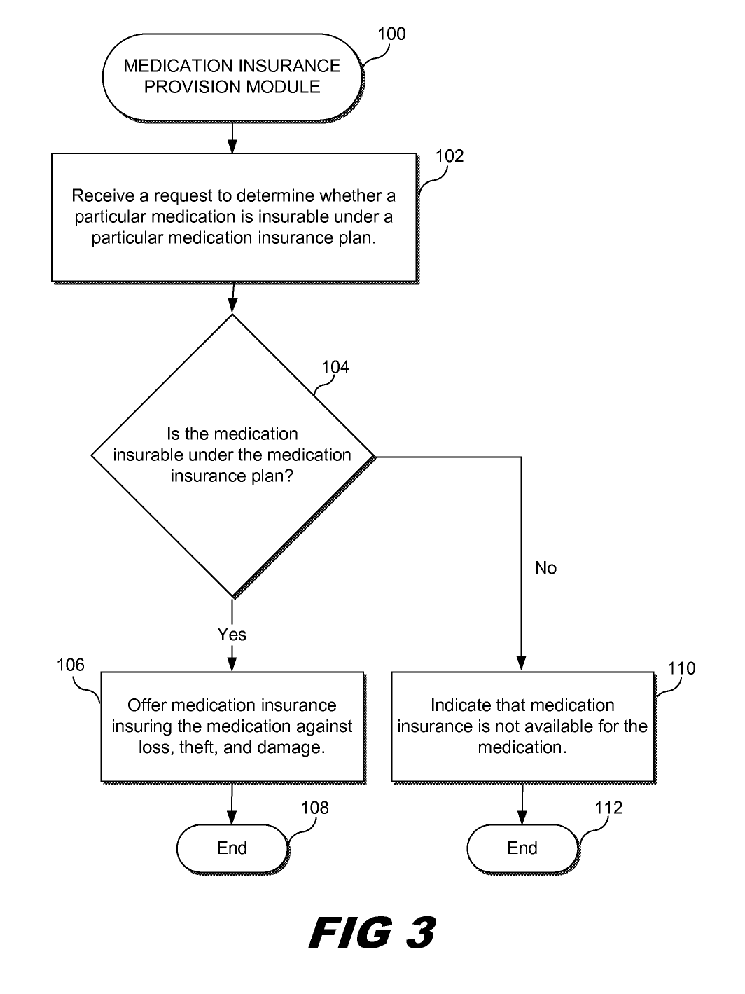

In particular embodiments, the Medication Insurance System 10 is adapted to offer prescription medication customers a medication insurance plan to protect the customer's prescription medication against loss, theft, and damage. FIG. 3 is a flow chart of an exemplary Medication Insurance Provision Module 100. As may be understood from FIG. 3, certain embodiments of the Medication Insurance Provision Module 100 are configured to provide users of prescription medication with a medication insurance plan that insures one or more of the users' prescription medications against loss, theft, and/or damage. For example, beginning at Step 102, the Medication Insurance Provision Module 100 may receive a request to determine whether a particular medication and/or prescription is insurable under a particular medication insurance plan. This request may be entered, for example, by a pharmacist filling a prescription, or by a patient who enters the request on-line (e.g., via a personal computer or a portable computing device, such as a cell phone).

In particular embodiments, the system may make the request automatically when a pharmacist or other individual initially enters a patient's prescription information into a prescription processing computer (e.g., a pharmacy computer) or when a customer orders prescription medication via the Internet or other computer network. Also, in some embodiments, the system may make the request automatically when a non-prescription drug is entered into a computer system or cash register for purchase.

Next, at Step 104, the Medication Insurance Provision Module 100 determines whether the prescription is insurable under the medication insurance plan. For example, the system may make this determination based, at least in part, on one or more of the following criteria: (1) whether the prescribed medication is on a list of accepted pharmaceuticals; (2) whether the prescription medication's price exceeds a pre-defined maximum price threshold (if so, the system may determine, for example, that the prescription is not insurable under the medication insurance plan); (3) whether the prescription is legally refillable and/or replaceable; or (4) any other suitable criteria. In response to determining that the prescription is eligible for the medication insurance plan, the system then, at Step 106, may display information regarding the medication insurance plan. Such information may include, for example: (1) an invitation to the patient to purchase a medication insurance policy for their prescribed medication; (2) an indication of the cost and terms of the medication insurance policy; and/or (3) any other suitable information. In various embodiments, the system is further configured for accepting payment for the medication insurance policy (e.g., via a credit card), for accepting the patient's enrollment information, and for issuing the policy to the patient. The system may be further configured for storing and maintaining data relating to the policy in any suitable manner.

In particular embodiments, the system may receive a request to insure multiple prescription medications at one time. In various embodiments, Steps 104 and 106, above, may be carried out individually for each prescription, or for the prescriptions collectively. In particular embodiments, the system may offer medication insurance for any combination of medications covered by the multiple prescriptions (e.g., a patient may choose to insure a single prescription medication or multiple prescription medications including all of the prescription medications).

### Refillable Prescriptions

As discussed above, in various embodiments, at Step 104, the Prescription Insurance Provision Module 100 may determine whether a particular prescription is insurable under the medication insurance plan, at least in part, based on whether the prescription is refillable and/or replaceable. For example, in certain embodiments, the system may only determine that a particular prescription is insurable if the prescription is refillable and/or replaceable. The system may make this determination by, for example: (1) determining whether the prescription is refillable on its face; and/or (2) contacting the prescribing medical practitioner (e.g., a physician or dentist) to determine whether the medical practitioner would issue a replacement prescription in the event that the patient's medication is lost, damaged, or stolen.

In various embodiments, the system may determine whether a particular medical practitioner will issue a substitute prescription for the medication by accessing a database that includes information regarding the medical practitioner's standard practices regarding issuing substitute prescriptions for lost, stolen, or damaged medications. In particular embodiments, this information includes detailed, medication-specific information regarding the medical practitioner's prescription replacement practices. In other embodiments, the system may send an automated message (e.g., a text message or e-mail) to the medical practitioner's office asking whether the medical practitioner will issue a replacement prescription for the medication. In yet further embodiments, the system may send or display a message to an account representative, who may contact the medical practitioner's office to determine whether the medical practitioner will issue a replacement prescription for the medication.

### Medication Insurance Plan Cost

As noted above, the Prescription Insurance Provision Module 100 may be configured to determine the cost of insuring a particular prescription. For example, the system may make this determination, based at least in part, on such factors as: (1) the replacement cost of the medication; (2) the copayment amount paid to a primary insurance carrier during an initial filling of a prescription for the medication; and/or (3) any other suitable factor.

### Medication Insurance Claims Module

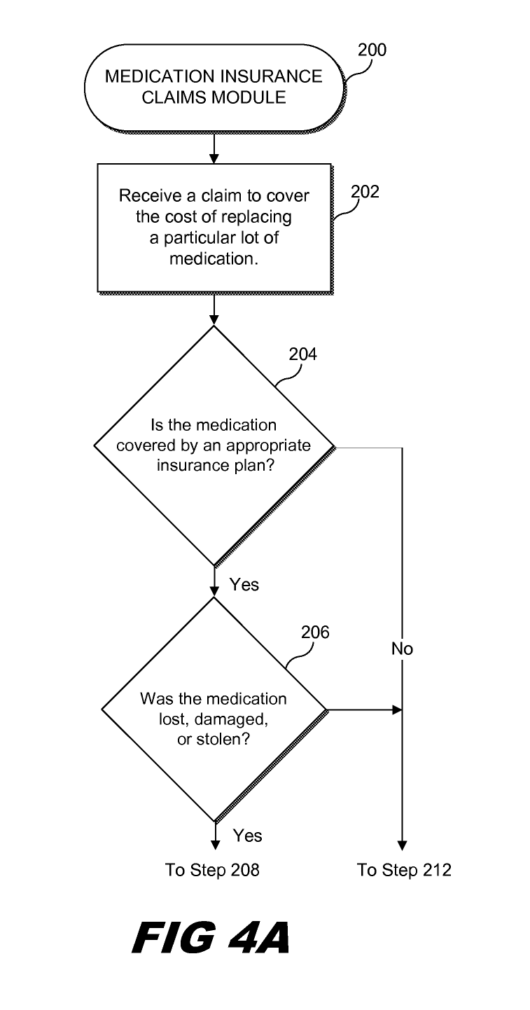

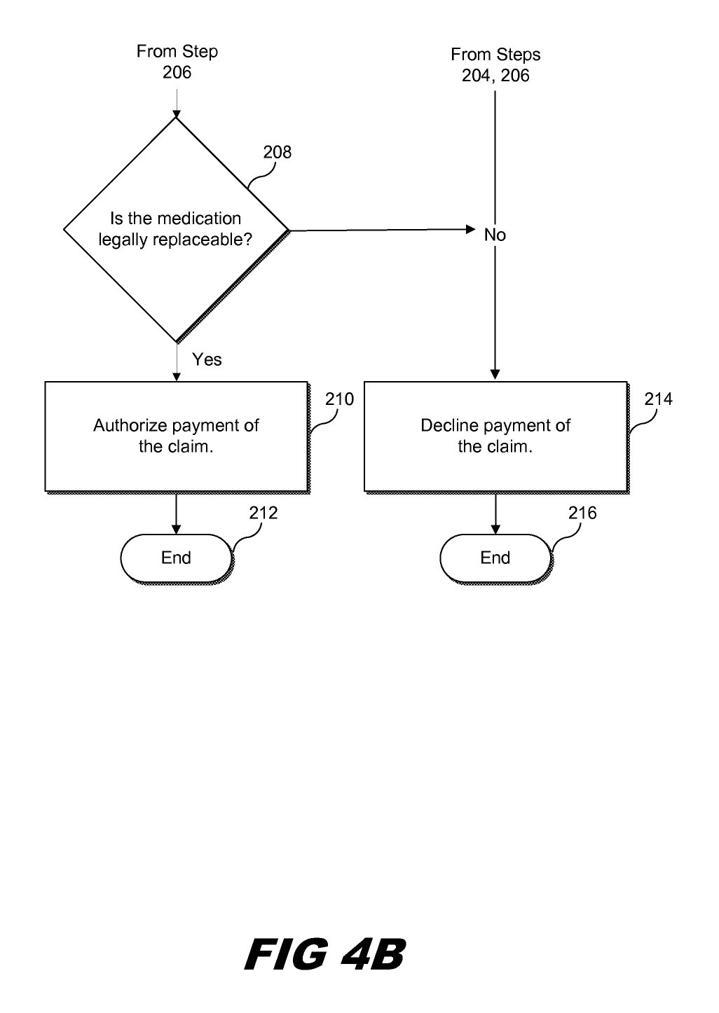

As noted above, in particular embodiments, the system may be adapted to process claims filed under a particular medication insurance policy (e.g., a particular policy issued by the system). FIG. 4 is a flow chart of an exemplary Claims Processing Module 200 that is adapted to process such claims. In various embodiments, when executing the Claims Processing Module 200, the system begins at Step 202 where it receives a claim to reimburse the cost of replacing a particular lot of medication.

Next, at Step 204, the system determines whether the lot of medication is covered by an appropriate medication insurance plan. (The system may do this, for example, by accessing a database to determine whether a medication insurance plan corresponds to the particular lot of medication at issue.)

If the answer to the inquiry of Step 204 is yes, the system advances to Step 206, where the system determines whether the medication was lost, stolen, or damaged. (The system may make this determination, for example, by accessing a database to determine whether the individual has submitted an appropriate statement verifying that the medication has been lost, stolen, or damaged.)

If the answer to the inquiry of Step 206 is yes, the system advances to Step 208, where it determines whether the medication is legally replaceable. The system may do this, for example, by: (1) accessing information regarding the prescription for the lot of medication to determine whether the prescription has any refills remaining; and/or (2) by determining whether a physician—for example, the physician who originally prescribed the medication—is willing to issue a substitute prescription for the medication.

In various embodiments, the system may determine whether a particular physician will issue a substitute prescription for the medication by accessing a database that includes information regarding the physician's standard practices regarding issuing substitute prescriptions for lost, stolen, or damaged medications. In particular embodiments, this information includes detailed, medication-specific information regarding the physician's prescription replacement practices. In other embodiments, the system may send an automated message (e.g., a text message or e-mail) to the physician's office asking whether the physician will issue a replacement prescription for the medication. In yet further embodiments, the system may send or display a message to an account representative, who may contact the physician's office to determine whether the physician will issue a replacement prescription for the medication.

If the answer to the inquiry of Step 208 is yes, the system advances to Step 210, where it authorizes payment of the claim. In various embodiments, the system may either authorize payment for a full refill of the prescription, for a partial refill of the prescription, or for some other appropriate amount. The system then proceeds to Step 212 where it ends execution of the Medication Insurance Claims Module 200.

If the answer to the inquiry of any of Steps 204, 206, or 208 is no, the system advances to Step 214, where it declines payment of the claim. The system then proceeds to Step 216 where it ends execution of the Medication Insurance Claims Module 200.

### Implementation of Medication Insurance Plan

An example of a particular implementation of a medication insurance computer system will now be discussed. In this example, the computer system is implemented within the context of a pharmacy. When an individual presents a prescription to a pharmacist to be filled, the pharmacist uses the pharmacy's computer (which may be regarded as an “input computer” 14) to transmit information about the prescription to the Medication Insurance Server 50. The Medication Insurance Server 50 then executes the Medication Insurance Provision Module 100 to determine whether medication insurance is available for the prescription as discussed above. If so, the Medication Insurance Server 50 displays a message to the pharmacist (e.g., via a web browser that is being run on the pharmacy's computer) indicating that medication insurance is available for the prescription. The pharmacist then offers to sell the medication insurance to the individual for a price that may be, for example, determined by the Medication Insurance Server 50. The insurance may, for example, cover the cost of replacing a particular medication that was issued under the prescription in the event that the medication is lost, stolen, damaged, or somehow otherwise becomes unavailable for use by the individual.

After the individual purchases the medication insurance, if medication covered by the insurance is lost, stolen, or damaged (or sustains another qualifying event that is covered by the insurance), the individual may go to a participating pharmacy and file a claim under their medication insurance policy to replace the medication at issue. Once the individual completes any necessary paperwork, a pharmacist at the pharmacy uses the pharmacy's computer to transmit information about the claim to the Medication Insurance Server 50. The Medication Insurance Server then executes the Medication Insurance Claims Module 200 to determine whether to authorize payment of the individual's claim. If so, the Medication Insurance Server 50 displays a message to the pharmacist (e.g., via a web browser that is being run on the pharmacy's computer) indicating that the individual's insurance will cover the cost of replacing the medication. The medication insurance system 10 may then also facilitate payment of the pharmacy for the replacement medication. The pharmacist, or other pharmacy worker, then takes the appropriate steps to replace the medication that has become unavailable to the individual. For example, the pharmacist may refill the individual's current prescription, or contact the physician who issued the prescription to request a replacement and then fill the replacement prescription.

### CONCLUSION

Many modifications and other embodiments of the invention will come to mind to one skilled in the art to which this invention pertains having the benefit of the teachings presented in the foregoing descriptions and the associated drawings. For example, while various embodiments are described above as being implemented in the context of prescriptions that are filled in person at a pharmacy, the system may also be used in other contexts, such as in the context of on-line prescription or non-prescription medication orders. In addition, while particular embodiments are described in the context of medication insurance, similar techniques may be used within the context of non-insurance products that would provide for replacement of medications upon the occurrence of various specified events (e.g., the medications being lost, stolen, or damaged). Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

I claim:

1. A computer-readable medium storing computer readable instructions for:
receiving information that may be used to identify a prescribed medication;
determining whether it would be possible to legally replace said prescribed medication if said prescribed medication were to become subject to an event selected from a group consisting of loss, theft, and damage; and
in response to determining that it would be possible to legally replace said prescribed medication if said prescribed medication were to become subject to an event selected from a group consisting of loss, theft, and damage, facilitating the offering of a medication insurance plan covering said prescribed medication, wherein:
said medication insurance plan insures said prescribed medication against at least one event selected from a group consisting of loss, theft, and damage.

2. The computer-readable medium of claim 1, wherein said medication insurance plan insures said prescribed medication against loss.

3. The computer-readable medium of claim 1, wherein said medication insurance plan insures said prescribed medication against theft.

4. The computer-readable medium of claim 1, wherein said information is received as part of a request to fill a prescription for said prescribed medication.

5. The computer-readable medium of claim 1, wherein said step of determining whether it would be possible to legally replace said prescribed medication comprises determining whether a particular medical practitioner that issued said prescription would issue a replacement prescription if said prescribed medication were to become subject to an event selected from a group consisting of loss, theft, and damage.

6. The computer-readable medium of claim 5, wherein said step of determining whether said particular medical practitioner that issued said prescription would issue a replacement prescription comprises transmitting an automated message to said medical practitioner inquiring whether said medical practitioner would issue a replacement prescription if said prescribed medication becomes subject to an event selected from a group consisting of loss, theft, and damage.

7. The computer-readable medium of claim 5, wherein said step of determining whether said particular medical practitioner that issued said prescription would issue a replacement prescription comprises accessing a database of information to determine whether said medical practitioner would issue a replacement prescription if said prescribed medication becomes subject to an event selected from a group consisting of loss, theft, and damage.

8. The computer-readable medium of claim 7, wherein said database comprises information indicating whether said medical practitioner would, as a standard practice, be willing to issue a replacement prescription for one or more specific medications in the event that said one or more specific medications becomes subject to an event selected from a group consisting of loss, theft, and damage.

9. The computer-readable medium of claim 1, wherein said step of determining whether it would be possible to legally replace said prescribed medication comprises determining whether said prescription is refillable.

10. A medication insurance computer system for facilitating the processing of medication insurance claims, said medication insurance computer system comprising:
a computer processor; and
memory, wherein said medication insurance computer system is adapted for:
receiving a claim to cover a cost of replacing a particular prescription medication;
determining whether said prescription medication is covered by a medication insurance plan, wherein said medication insurance plan protects said prescription medication against at least one event selected from a group consisting of loss, theft, and damage;
determining, in a substantially automated manner, whether it would be possible to legally replace said prescription medication; and
at least partially in response to determining that said missing prescription medication is covered by said medication insurance plan and that it would be possible to legally replace said prescription medication, authorizing payment of said claim.

11. The medication insurance computer system of claim 10, wherein said step of determining whether it would be possible to legally replace said prescription medication comprises determining whether a particular medical practitioner that issued a prescription for said prescription medication would issue a replacement prescription if said prescription medication were to become subject to an event selected from a group consisting of loss, theft, and damage.

12. The medication insurance computer system of claim 11, wherein said step of determining whether said particular medical practitioner that issued said prescription would issue a replacement prescription comprises transmitting an automated message to said medical practitioner inquiring whether said medical practitioner would issue a replacement prescription if said prescribed medication becomes subject to an event selected from a group consisting of loss, theft, and damage.

13. The medication insurance computer system of claim 11, wherein said step of determining whether said particular medical practitioner that issued said prescription would issue a replacement prescription comprises accessing a database of information to determine whether said medical practitioner would issue a replacement prescription if said prescribed medication becomes subject to an event selected from a group consisting of loss, theft, and damage.

14. The medication insurance computer system of claim 13, wherein said database comprises information indicating whether said medical practitioner would, as a standard practice, be willing to issue a replacement prescription for one or more specific medications in the event that said one or more specific medications becomes subject to an event selected from a group consisting of loss, theft, and damage.

15. The medication insurance computer system of claim 10, wherein said step of determining whether it would be possible to legally replace said prescription medication comprises determining whether said prescription is refillable.

16. A method of providing a medication insurance plan comprising the steps of:
receiving a request to fill a prescription for prescription medication; and
at least partially in response to receiving said request, issuing an offer to provide a medication replacement plan that would at least partially cover a cost of replacing the prescription medication if the medication becomes subject to an event selected from a group consisting of loss, theft, and damage.

17. The method of claim 16, wherein said step of issuing an offer to provide said medication replacement plan is executed by a computer.

18. The method of claim 16, wherein said method further comprises determining whether it would be possible to legally replace said prescription medication.

19. The method of claim 18, wherein said step of issuing said offer is done at least partially in response to determining that it would be possible to legally replace said prescription medication.

20. The computer-readable medium of claim 18, wherein said step of determining whether it would be possible to legally replace said prescription medication comprises determining whether said prescription is refillable.

21. The computer-readable medium of claim 18, wherein said step of determining whether it would be possible to legally replace said prescription medication comprises determining whether a particular medical practitioner that issued a prescription for said prescription medication would issue a replacement prescription if said prescription medication were to become subject to an event selected from a group consisting of loss, theft, and damage.

22. The computer-readable medium of claim 21, wherein said step of determining whether said particular medical practitioner that issued said prescription would issue a replacement prescription comprises accessing a database of information to determine whether said medical practitioner would issue a replacement prescription if said prescribed medication becomes subject to an event selected from a group consisting of loss, theft, and damage.
